(19) United States
(12) Patent Application Publication
(10) Pub. No.: US 2025/0379959 A1
(43) Pub. Date: Dec. 11, 2025

(54) IMAGE SENSOR AND IMAGE PROCESSING METHOD THEREOF

(71) Applicant: Samsung Electronics Co., Ltd., Suwon-si (KR)

(72) Inventors: Chanyoung JANG, Suwon-si (KR); Yongseong KIM, Suwon-si (KR); Gyeongsung YOU, Suwon-si (KR)

(73) Assignee: Samsung Electronics Co., Ltd., Suwon-si (KR)

(21) Appl. No.: 19/002,203

(22) Filed: Dec. 26, 2024

(30) Foreign Application Priority Data
Jun. 7, 2024 (KR) 10-2024-0074433

(51) Int. Cl. H04N 9/64; G06T 5/80

(52) U.S. Cl. CPC H04N 9/646; G06T 5/80; G06T 2207/10024; G06T 2207/30168

(57) ABSTRACT

Provided is an image sensor that includes a pixel array including a plurality of pixels in a plurality of rows and a plurality of columns, and an image signal processor (ISP) configured to process a raw image generated by the pixel array to generate an output image, wherein the ISP is configured to obtain the raw image, generate RGB image data based on the raw image, generate corrected RGB image data by applying a selected image data processing method to the RGB image data, identify an image distortion level corresponding to each pixel of the RGB image data by comparing the RGB image data and the corrected RGB image data, correct each chrominance value corresponding to each pixel of the RGB image data based on the image distortion level corresponding to each pixel of the RGB image data, and generate the output image based on each corrected chrominance value.

### CROSS-REFERENCE TO RELATED APPLICATION(S)

This application claims the benefit of Korean Patent Application No. 10-2024-0074433, filed on Jun. 7, 2024, in the Korean Intellectual Property Office, the disclosure of which is incorporated herein by reference.

### BACKGROUND

### 1. Field of the Invention

Example embodiments relate to image sensors and methods of processing an image of the same.

### 2. Description of the Related Art

An image sensor is a device that captures a two-dimensional or three-dimensional image of an object. The image sensor may create an image of an object using a photoelectric conversion element that reacts according to the intensity of light reflected from the object. With the recent development of complementary metal-oxide semiconductor (CMOS) technology, CMOS image sensors using a CMOS are being widely used. The image sensor may perform various image data processing operations to create an output image based on a raw image generated from a pixel array. For example, remosaic processing based on interpolation and/or extrapolation may be performed to convert an image into a form that can be processed by an application processor (AP).

### SUMMARY

Some aspects provide image sensors and methods of processing image data of the image sensor by which color distortion (artifact) that may occur during image data processing in the AP may be alleviated by the color correction on image data in the image data processing operations in the image sensor.

The technical tasks to be achieved by the present example embodiments are not limited to the technical tasks described above, and other technical tasks may be inferred from the following example embodiments.

According to some aspects, there is provided an image sensor that includes a pixel array including a plurality of pixels arranged in a plurality of rows and a plurality of columns, and an image signal processor (ISP) configured to process a raw image generated by the pixel array to generate an output image, wherein the ISP is configured to obtain the raw image, generate RGB image data based on the raw image, generate corrected RGB image data by applying a selected image data processing method to the RGB image data, identify an image distortion level corresponding to each pixel of the RGB image data by comparing the RGB image data with the corrected RGB image data, correct each chrominance value corresponding to each pixel of the RGB image data based on the image distortion level corresponding to each pixel of the RGB image data, and generate the output image based on each corrected chrominance value.

According to some aspects, there is provided an image processing system that includes an image sensor including a pixel array including a plurality of pixels arranged in a plurality of rows and a plurality of columns, and an image signal processor (ISP) configured to process a raw image generated by the pixel array to generate an output image, and an application processor (AP) configured to process the output image to generate a final output image, wherein the ISP is configured to obtain the raw image, generate RGB image data based on the raw image, generate corrected RGB image data by applying a selected image data processing method to the RGB image data, identify an image distortion level corresponding to each pixel of the RGB image data by comparing the RGB image data and the corrected RGB image data, correct a chrominance value corresponding to each pixel of the RGB image data based on the image distortion level corresponding to each pixel of the RGB image data, and generate the output image based on a corrected chrominance value.

According to some aspects, there is provided an image processing method that includes obtaining a raw image generated by a pixel array, generating RGB image data based on the raw image, generating corrected RGB image data by applying a selected image data processing method to the RGB image data, identifying an image distortion level corresponding to each pixel of the RGB image data by comparing the RGB image data and the corrected RGB image data, correcting a chrominance value corresponding to each pixel of the RGB image data based on the image distortion level corresponding to each pixel of the RGB image data, and generating an output image based on a corrected chrominance value.

According to some aspects, there is provided a non-transitory computer-readable recording medium having a program for executing the operating methods on a computer.

Additional aspects of example embodiments will be set forth in part in the description which follows and, in part, will be apparent from the description, or may be learned by practice of the disclosure.

According to some example embodiments, it may be possible to alleviate color distortion in final output image data by preprocessing to compensate for pixel values regarding pixels wherein color distortion is expected to occur due to error occurring in the image data processing operations. Accordingly, image sensors with improved output image quality may be provided, and/or the image processing may be faster, more resource efficient, and/or accurate.

The effects to be obtained in the present disclosure are not limited to the aforementioned effects, and other effects not mentioned herein will be clearly understood by those skilled in the art from the following description.

### BRIEF DESCRIPTION OF THE DRAWINGS

These and/or other aspects, features, and advantages of the inventions will become apparent and more readily appreciated from the following description of example embodiments, taken in conjunction with the accompanying drawings of which:

FIG. 1 is a block diagram illustrating an image processing system according to some example embodiments;

FIGS. 2A to 2C are diagrams illustrating pixel arrays according to some example embodiments;

FIG. 2D is a diagram illustrating a method of converting an image sensed by an image sensor into a Bayer pattern according to some example embodiments;

FIG. 3 is a flowchart illustrating the operation of an ISP performing an image processing method according to some example embodiments;

FIGS. 4A to 4C are diagrams for explaining the operation of an ISP according to some example embodiments; and

FIG. 5 is a diagram illustrating an output image to which an image processing method is applied according to some example embodiments.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments will be described in detail with reference to the drawings.

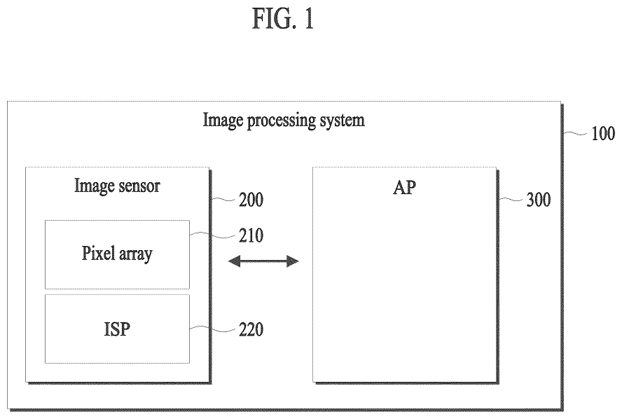

FIG. 1 is a block diagram illustrating an image processing system according to some example embodiments.

Referring to FIG. 1, an image processing system 100 may include an image sensor 200 and an application processor (AP) 300.

According to some example embodiments, the image sensor 200 may be implemented as a semiconductor chip or a package including a pixel array 210 including a plurality of pixels arranged in the two dimension, and an image signal processor (ISP) 220.

According to some example embodiments, the pixel array 210 may be implemented as a photoelectric conversion element such as a charge coupled device (CCD) or a CMOS that converts received optical signals into electrical signals. In addition thereto, the pixel array 210 may be implemented with various types of photoelectric conversion elements.

According to some example embodiments, the pixel array 210 may include a plurality of pixels arranged in a matrix form consisting of a plurality of rows and a plurality of columns. In order to generate a color image, each pixel may be combined with one of a red filter, a green filter, and a blue filter. The red, green, and blue color filters may be placed at corresponding positions on the pixel array 210 according to a specific pattern. The electrical signal generated from each pixel may include a color value according to the color filter corresponding to each pixel. This array of color filters may be called a color filter array (CFA).

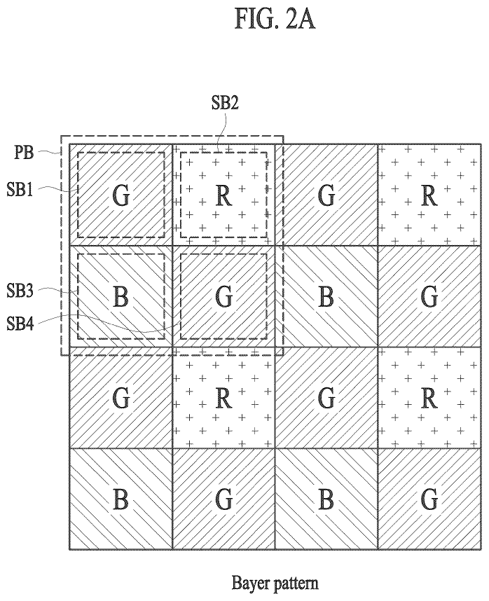

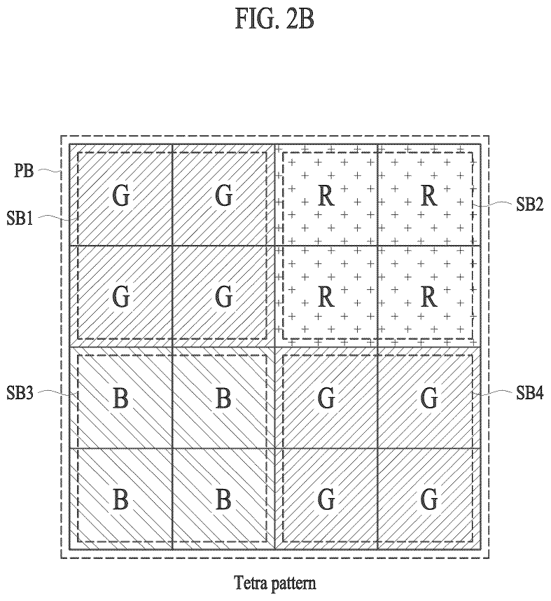

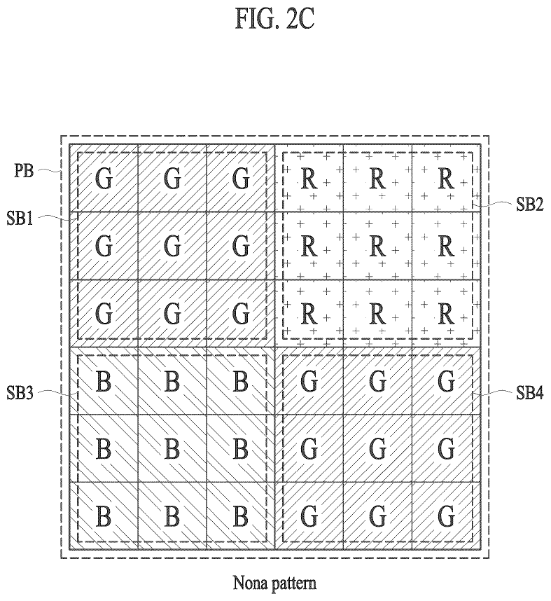

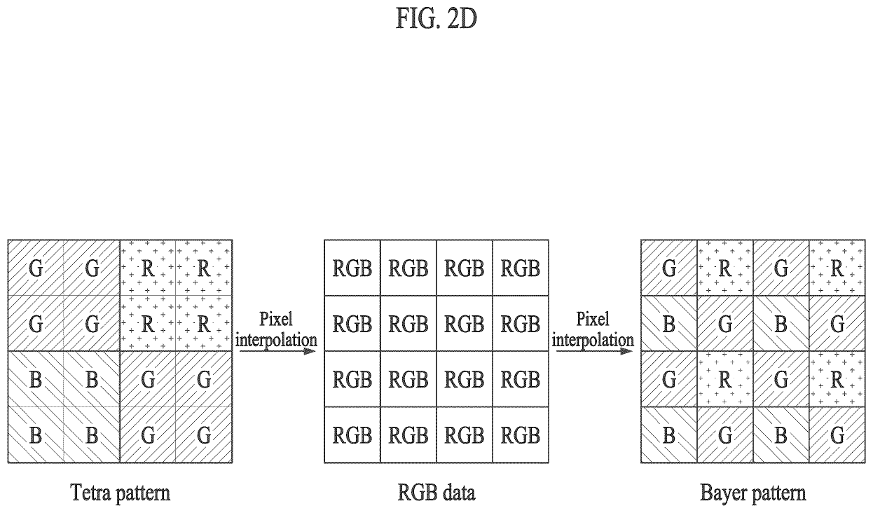

According to some example embodiments, the pixel array 210 may include multiple pixel blocks (PBs). Each PB may contain a plurality of pixels. Each PB may have a specific color filter pattern. Since each PB has a specific pattern, the pixel array 210 including a plurality of PBs may have a repeating color filter pattern. Further, a PB may include sub blocks containing one or more pixels. Color filters of the same color may be placed on pixels included in one sub block. Example embodiments of a pixel array including a PB and sub blocks will be described later with reference to FIGS. 2A to 2C.

According to some example embodiments, the ISP 220 may obtain image data generated from the pixel array 210. Various data processing operations may be performed on the obtained image data. In some example embodiments, the ISP 220 may perform X-talk correction and/or bad pixel correction on the obtained image data. Further, the ISP 220 may convert the obtained image data into a form of data that may be processed by the AP 300. As described above, the pattern of image data generated in the pixel array 210 is determined by the arrangement of the CFA. Meanwhile, the AP 300 may be configured to process image data of a Bayer pattern. Therefore, when the image generated from the pixel array 210 is not a Bayer pattern image, the ISP 220 converts the image into a Bayer pattern image and transmits the Bayer pattern image to the AP 300, allowing the AP 300 to process image data normally. Example embodiments of a method by which the ISP 220 converts an image generated from the pixel array 210 into a Bayer pattern will be described later with reference to FIG. 2D.

According to some example embodiments, the AP 300 may obtain image data from the image sensor 200, and may perform various data processing operations on obtained image data. The AP 300 may include a separate ISP for processing image data obtained from the image sensor 200, and this may indicate that the AP 300 itself processes image data. In some example embodiments, on the obtained image data, the AP 300 may perform various image data processing to reduce noise and improve image quality, such as black level adjustment, bad pixel correction, white balancing, demosaicing, shading correction, color correction, gamma correction, color conversion, edge enhancement, contrast enhancement and/or resizing. The image data processed by the AP 300 may be transmitted to an external device (for example, a display device) or may be stored in a separate storage device.

FIGS. 2A to 2C are diagrams illustrating pixel arrays according to some example embodiments.

FIG. 2A illustrates a pixel array arranged according to a Bayer pattern. The Bayer pattern is composed to include 50% green, 25% red and 25% blue, for example, reflecting the human eye's sensitivity, and in particular, sensitivity to green in natural light. For example, a PB constituting the Bayer pattern pixel array may include a first sub block SB1 to a fourth sub block SB4. The first sub block SB1 and the fourth sub block SB4 are configured to correspond to green, a second sub block SB2 is configured to correspond to red, and a third sub block SB3 is configured to correspond to blue. Further, the PB which is a unit constructed in this way may be expanded up, down, left, and right depending on the size of the pixel array.

FIG. 2B illustrates a pixel array arranged according to a tetra pattern. The PB constituting a tetra pattern pixel array may include a first sub block, a second sub block, a third sub block and a fourth sub block. Like in the Bayer pattern, the first sub block SB1 and the fourth sub block SB4 may be configured to correspond to green, the second sub block SB2 may be configured to correspond to red, and the third sub block SB3 may be configured to correspond to blue. Meanwhile, each sub block that makes up the tetra pattern pixel array may be composed of 4 pixels in a 2×2 array, and pixels within the same sub block are configured to correspond to the same color. Likewise, the unit PB of the tetra pattern may be expanded up, down, left, and right depending on the size of the pixel array.

FIG. 2C illustrates a pixel array arranged according to a nona pattern. The PB Constituting the pixel array of the nona pattern may include a first sub block, a second sub block, a third sub block and a fourth sub block. As in the Bayer pattern, the first sub block SB1 and the fourth sub block SB4 may be configured to correspond to green, the second sub block SB2 may be configured to correspond to red, and the third sub block SB3 may be configured to correspond to blue. Meanwhile, each sub block that makes up the pixel array of the nona pattern may be composed of 9 pixels in a 3×3 array, and pixels within the same sub block are configured to correspond to the same color. Likewise, the unit PB of the tetra pattern may be expanded up, down, left, and right depending on the size of the pixel array.

FIGS. 2A to 2C illustrate example embodiments of pixel arrays, which are with the Bayer pattern, the tetra pattern and the nona pattern. However, the present disclosure is not limited thereto. The same may be applied to a pixel array containing various combinations of subpixels (for example, subpixels containing pixels arranged in M×N).

FIG. 2D is a diagram illustrating a method of converting an image sensed by an image sensor into a Bayer pattern according to some example embodiments.

As described above, the AP 300 may be configured to process Bayer pattern image data. Therefore, when a raw image sensed by the image sensor 200 has a pattern other than a Bayer pattern, such as the tetra pattern or the nona pattern, the raw image must be converted into the Bayer pattern and delivered to the AP. As such, the process of converting a raw image into a Bayer pattern image in the image sensor 200 is called remosaic.

According to some example embodiments, as illustrated in FIG. 2D, from a raw image, RGB image data may be generated where each pixel has the values of red R, green G and blue B, and a Bayer pattern image (or an image of a Bayer pattern) may be created based on the generated RGB image data. Meanwhile, since the image processing method according to some example embodiments includes processing the RGB image data, the remosaic process, which includes the process of generating the RGB image data based on the raw image, is Illustrated. However, the present disclosure is not limited thereto. A Bayer pattern image may be created directly from a raw image without conversion to RGB image data.

As illustrated in FIG. 2D, the process of converting a raw image into an image using a Bayer pattern may include generating RGB image data by interpolating the pixel value of each pixel of the raw image. Each pixel of the raw image sensed from the image sensor may have only one value among R, G, and B depending on the type of the corresponding color filter on the CFA, and thus, in order to generate the RGB image data, information about the remaining color values must be obtained by referring to the pixel values of adjacent pixels. According to some example embodiments, different methods of obtaining information about a desired color value by referring to the pixel value of an adjacent pixel may be used. For example, nearest interpolation, by which the nearest pixel value is referred to, bilinear interpolation, by which a desired pixel value is obtained based on a weighted average of the pixel values of adjacent pixels, bicubic interpolation, by which a desired pixel value is obtained based on the weighted average of 16 adjacent pixels, and/or spline interpolation, by which a pixel value at the desired interpolation point is estimated by generating a polynomial function that fits a specific data section. However, the present disclosure is not limited thereto. For example, other methods of obtaining a pixel value from adjacent pixel values may be used.

As illustrated in FIG. 2D, the process of converting a raw image into an image with a Bayer pattern may include generating a Bayer pattern image by interpolating the pixel value of each pixel of RGB image data. As described above, each pixel in a Bayer pattern image may have only one of R, G and B values, depending on the type of a corresponding color filter, and thus information about the color value of the color corresponding to each pixel of the Bayer pattern image must be obtained based on the R, G and B values of each pixel of the RGB image data. According to some example embodiments, the pixel value of the Bayer pattern image may be obtained by extracting the color value corresponding to the respective pixel of the Bayer pattern image from among the R, G and B values of each pixel of the RGB image data. The pixel value of the Bayer pattern image may be obtained by interpolating the pixel values based on the pixel values of adjacent pixels.

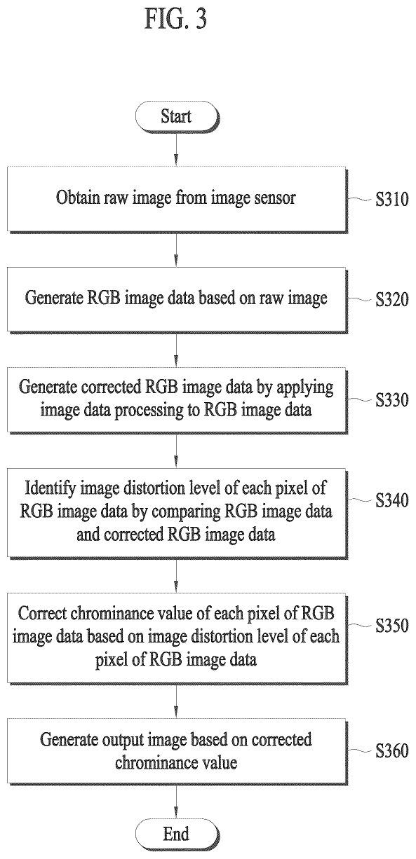

FIG. 3 is a flowchart illustrating the operation of an ISP performing an image processing method according to some example embodiments.

Each operation of the ISP 220 in FIG. 3 may be performed by the ISP 220 described above, and thus description of content that overlaps with FIGS. 1 to 2D will be omitted. However, each operation of the operation method of the ISP 220 may be partially changed or replaced, or some sequences between operations may be changed within the range clearly understood by those skilled in the art to which the example embodiments disclosed in the present disclosure belong.

Referring to FIG. 3, in operation S310, the ISP 220 may obtain a raw image from the image sensor 200. According to some example embodiments, a raw image may be a tetra pattern image or a nona pattern image, but the present disclosure is not limited thereto. As described above, a pattern of the raw image may be determined according to the arrangement of the CFA corresponding to the pixel array 210 in the image sensor 200.

In operation S320, the ISP 220 may generate RGB image data based on the raw image.

According to some example embodiments, the ISP 220 may generate an RGB image by interpolating pixel values based on the pixel values of the raw image. As described above, in a raw image, the color value corresponding to each pixel is determined according to the arrangement of the CFA corresponding to the pixel array 210 in the image sensor 200, and thus each pixel in a raw image may have only one value among R, G and B. Therefore, using the interpolation methods such as the nearest interpolation, the bilinear interpolation, the bicubic interpolation, and/or the spline interpolation, the ISP 220 may generate the RGB image data in which each pixel has all R, G and B values based on the pixel values of adjacent pixels in the raw image.

In operation S330, the ISP 220 may generate corrected RGB image data that is based on the RGB image data.

According to some example embodiments, the ISP 220 may generate corrected RGB image data by applying a predetermined (or, alternatively, desired, selected, or determined) image data processing method to the RGB image data. In some example embodiments, a predetermined (or, alternatively, desired, selected, or determined) image data processing method may include at least one image data processing method that allows the corrected RGB image data to have non-linearity. In some example embodiments, the corrected RGB image data may generate the RGB image data by applying at least one of the gamma correction, the color correction, and/or the shading correction.

The gamma correction may follow, for example, Weber's law, and the gamma correction refers to correcting non-linearity of human vision by modifying the intensity of the light input through a non-linear function reflecting the fact that human vision reacts sensitively to changes in brightness when the brightness is dark, and reacts insensitively to changes in brightness when the brightness is bright.

The color correction may be intended to correct inaccurate color expression depending on the characteristics of the image sensor. The color correction refers to the process of making the colors output from an image sensor match the colors seen by the human eye. The color correction may be performed by correcting the color of the RGB image data that is input in real time by multiplying the R, G and B values by increasing or decreasing the gain, respectively.

The shading correction may be used to correct a shading phenomenon in which the image becomes darker toward the outskirts due to the optical characteristics of the lens. By setting the gain in the peripheral part of the image to be larger than the gain in the central part, the overall shading of the image may become more balanced.

When the pixel value of the image data before correction has an error from the actual value since the gain applied to each pixel of the image data is different in the image data correction process, later, errors may be boosted during image data processing to reduce noise or improve image quality in the AP, and color distortion may occur in the image data output from the AP. Therefore, the present disclosure describes example embodiments to alleviate color distortion in the final output image data of the AP 300 in which, regarding pixels that are expected to cause color distortion during the image data correction process, the ISP 220 in the image sensor 200 may compensate for color distortion in advance. For example, according to some example embodiments, there may be an increase in speed, accuracy, and/or power efficiency of the image processing device based on the above methods. Therefore, the improved devices and methods overcome the deficiencies of the conventional devices and methods while reducing resource consumption, and improving data accuracy, and resource allocation (e.g., latency). Further, there is an improvement in user experience and image capture in the device by providing the improved process.

According to some example embodiments, each parameter related to the gamma correction, the color correction, and the shading correction applied to the RGB image data to generate the corrected RGB image data may be a parameter related to the gamma correction, the color correction, and the shading correction in the AP 300 that receives the image output from the image sensor 200. This is to predict in advance color distortion that may occur during image data processing in the AP 300 by comparing the corrected RGB image data generated based on the parameters related to gamma correction, color correction, and shading correction of the AP 300 with the RGB image data, and to compensate for the color distortion.

In operation S340, the ISP 220 may identify an image distortion level of each pixel of the RGB image data by comparing the RGB image data and the corrected RGB image data.

As described above, the corrected RGB image data is generated by applying a predetermined (or, alternatively, desired, selected, or determined) image data processing method to the RGB image data, and may include information about color distortion that may occur during image data processing. Therefore, by comparing the RGB image data and the corrected RGB image data, the degree of color distortion that occurs during image data processing may be identified.

According to some example embodiments, the ISP 220 may calculate an image distortion level of the RGB image data based on the edge connectivity of the RGB image data and the corrected RGB image data. For example, the difference between the two may be calculated by calculating the edge connectivity of each pixel of the RGB image data and the edge connectivity of each pixel of the corrected RGB image data. Further, depending on the brightness of the image, the effect due to differences in edge connectivity may vary, and thus based on the brightness of the image, the distortion weight corresponding to each pixel of the RGB image data may be determined.

According to some example embodiments, the ISP 220 may calculate an image distortion level corresponding to each pixel of the RGB image data based on the distortion weight. For example, a lower threshold value and an upper threshold value may be set in relation to the distortion weight, for pixels with a distortion weight below the lower threshold value, subsequent color correction may not be performed on the determination that color distortion will not occur, and pixel with a distortion weight greater than the upper threshold value may not be color corrected in the future, as the pixel is determined as a pixel with a large color difference from surrounding pixels in the actual image. Alternatively, for pixels with a distortion weight greater than the upper threshold value, the image distortion level corresponding to the pixels may be set to the maximum value. In some example embodiments, a lower threshold value and an upper threshold value may be set by the user and stored in the image sensor. Further, according to some example embodiments, the lower threshold value and the upper threshold value may be determined based on the characteristics of the image data. For example, the lower threshold value and the upper threshold value may be determined based on the brightness of the image data or the noise level of the image sensor. The lower threshold value and the upper threshold value may be determined based on the distribution of pixel values of each pixel of image data.

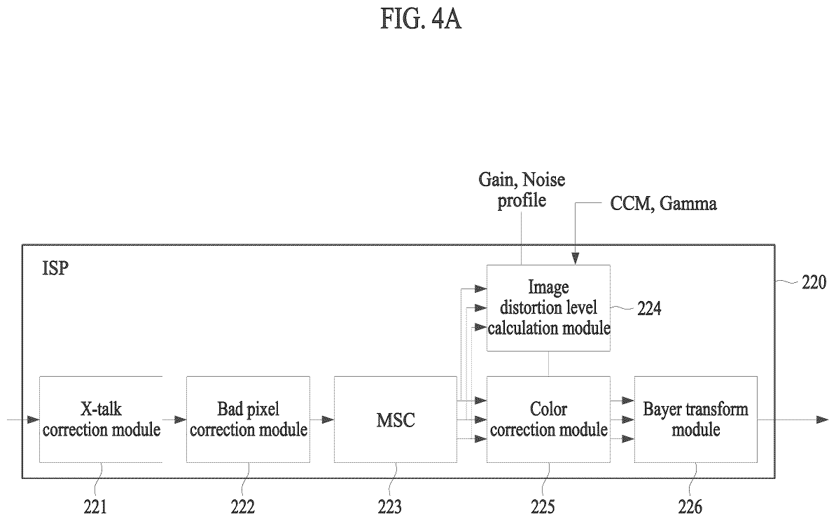

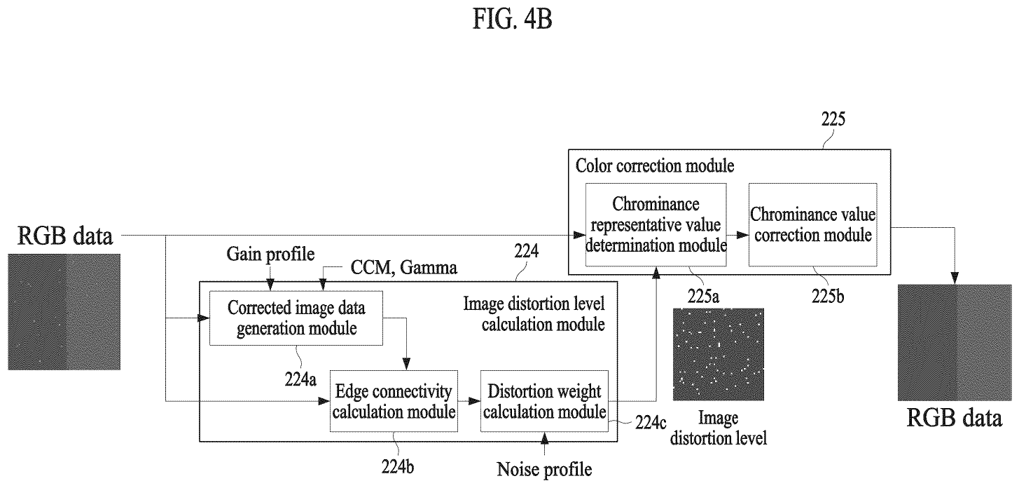

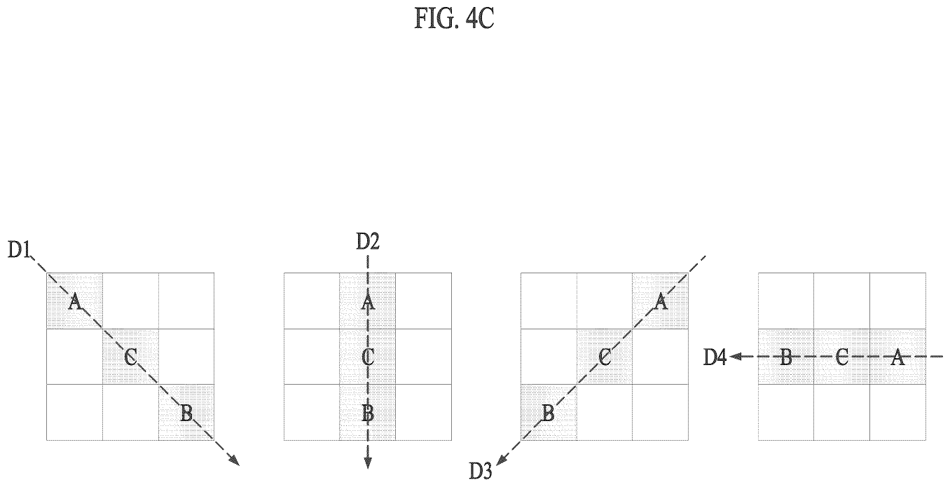

Described later with reference to FIGS. 4A to 4C are example embodiments related to methods for calculating edge connectivity for each of RGB image data and corrected RGB image data, and methods of identifying the image distortion level of each pixel of the RGB image data based thereon.

In operation S350, the ISP 220 may correct the chrominance value of each pixel of the RGB image data based on the image distortion level of each pixel of the RGB image data.

According to some example embodiments, the ISP 220 may alleviate color distortion through correction in which, for each pixel of the RGB image data, the higher the image distortion level corresponding to that pixel, in other words, the higher the likelihood that color distortion will be boosted during image data processing in the AP 300, the more the chrominance value of the corresponding pixel of the RGB image data is reduced.

The chrominance of image data may refer to a part of the image data that represents color information. The Smaller the chrominance, the closer the image is to grayscale and the less color differences there are (e.g., as less color is present, the chrominance may decrease), and thus the image may appear focused on light and dark and colors or hues of the image may not be emphasized. Therefore, through a correction that reduces the chrominance value of a specific pixel of the RGB image data, even if pixel value errors are boosted during the image data correction process within the AP, color distortion in the final output image may be alleviated. Described later with reference to FIGS. 4A and 4B are example embodiments related to method of correcting chrominance of each pixel of the RGB image data based on the image distortion level of each pixel of the RGB image data.

In operation S360, the ISP 220 may generate an output image based on the corrected chrominance value. In some example embodiments, the output image may be displayed on a display device (not shown) or stored in a memory (not shown).

According to some example embodiments, an output image may be a Bayer pattern image. As described above, the AP 300 may be configured to process Bayer pattern image data. Therefore, by outputting the image of the Bayer pattern and transmitting the image to the AP 300, the ISP 220 may ensure that processing the image data in the AP 300 is performed smoothly.

In order to generate the output image of the Bayer pattern, the ISP 220 may generate output YUV image data based on the chrominance value in which the chrominance of each pixel is corrected. After then, based on the output YUV image data, output RGB image data may be generated through YUV-to-RGB conversion, and an output image may be created by converting the output RGB image data into a Bayer pattern through interpolation of each pixel value. Meanwhile, the present disclosure is not limited thereto. Depending on the data type required in the subsequent process for processing the output image of the ISP 220, the process of converting output YUV image data into data of a desired format may be performed.

FIGS. 4A to 4C are diagrams for explaining the operation of an ISP according to some example embodiments.

Referring to FIG. 4A, the ISP 220 may include at least some of an X-talk correction module 221, a bad pixel correction module 222, a remosaic (MSC) module 223, an image distortion level calculation module 224, a color correction module 225, and a Bayer transform module 226. All or part of the modules within the ISP 220 may be integrated together on one chip, and/or may be implemented as separate chips. Further, each module within the ISP 220 may be controlled to perform operations described below by instructions stored within the ISP 220 or in a memory configured separately from the ISP 220.

According to some example embodiments, the ISP 220 may perform image data processing based on image data obtained from the image sensor 200. For example, in the X-talk correction module 221, the heights at which a plurality of color filters are created on the pixel groups constituting the pixel array 211 are different from each other, and thus, the effect caused by crosstalk between pixels that occurs may be corrected. In the bad pixel correction module 222, a location of the defective pixel may be detected, and a pixel value of a defective pixel may be corrected based on the pixel value of the pixel adjacent to the corresponding pixel. The MSC module 223 may perform the remosaic operation on image data that is input to the MSC module 223, and output RGB image data as a result of performing the remosaic operation. Further, as described above, the AP 300, which receives image data from the image sensor 200 and processes the image data, may be an AP for processing Bayer pattern image data. If the image data obtained from the ISP 220 is not Bayer pattern image data, in the Bayer transform module 226, image data may be converted to image data of the Bayer pattern.

Further, in order to generate Bayer pattern image data based on image data other than Bayer pattern, interpolation of pixel values within image data may be performed and in the interpolation process of pixel values, errors from the actual values may occur. The errors may be boosted during image data processing within the AP 300, and thus the ISP 220 may perform image data processing operations to alleviate color distortion due to error in pixel values in the image distortion level calculation module 224 and the color correction module 225.

FIG. 4B is a diagram for explaining operations of the image distortion level calculation module 224 and the color correction module 225.

According to some example embodiments, the image distortion level calculation module 224 may be a module for calculating the image distortion level of each pixel of RGB image data based on the RGB image data, and may include a corrected image data generation module 224a, an edge connectivity calculation module 224b and a distortion weight calculation module 224c.

According to some example embodiments, the corrected image data generation module 224a may output RGB image data reflecting non-linearity associated with image data processing by performing predetermined (or, alternatively, desired, selected, or determined) image data processing on the input RGB image data. The corrected RGB image data may be image data that is generated by applying at least one of the gamma correction, the color correction, and the shading correction to the RGB image data that is input to the corrected image data generation module 224a. Each parameter with respect to the gamma correction, the color correction, and the shading correction may be determined based on parameters related to the gamma correction, the color correction, and the shading correction obtained from the AP 300.

According to some example embodiments, the edge connectivity calculation module 224b may calculate edge connectivity for each pixel of each image data having the input RGB image data of the image distortion level calculation module 224 and the corrected RGB image data generated as the output of the corrected image data generation module 224a as input data. More specifically, the edge connectivity calculation module 224b may calculate edge connectivity of a reference pixel based on a pixel value of a reference pixel and each pixel value of pixels neighboring the reference pixel, for each pixel of the input RGB image data. FIG. 4C is a diagram for explaining a method for calculating edge connectivity of the RGB image data.

FIG. 4B is to explain a method of calculating edge connectivity when the ISP 220 processes image data in units of 3×3 kernels. However, the size of the kernel is not limited thereto, and in some example embodiments, the ISP 220 may process image data in kernel units of various sizes, such as 5×5 and 7×7.

In general, in at least one of the horizontal, vertical, and diagonal directions, pixel values of the image data must have similar values to neighboring pixel values, and it may be determined that the larger the difference between neighboring pixel values, the less edge connectivity there is. Therefore, the ISP 220 uses the center pixel of the kernel as a reference pixel, and the ISP 220 may calculate the difference between a pixel value C of the reference pixel and pixel values A and B of neighboring pixels in the horizontal, vertical, and diagonal directions D1 to D4, respectively. As shown in Equation 1 below, the ISP 220 may determine the minimum value among the differences between pixel values for each direction as edge connectivity (Imin) with respect to the reference pixel.

$${I}_{min} = min ( diff ( C , \frac{A + B}{2} ) ) \qquad [ Equation 1 ]$$

According to some example embodiments, the distortion weight calculation module 224c may calculate the distortion weight for each pixel of the RGB image data by inputting the edge connectivity for each pixel of the RGB image data and the edge connectivity for each pixel of the corrected RGB image data. More specifically, it may be expected that the larger the difference between edge connectivity for each pixel in the RGB image data and edge connectivity for a pixel in the corrected RGB image data corresponding to that pixel, the more color distortion is boosted during the image data correction process in the AP 300. Further, the brighter the image, the less likely the effect of differences in pixel values may be boosted in the final output image, and thus the distortion weight may be calculated considering the brightness of the image. Here, the brightness of the image may be determined by considering the noise level of the image sensor 200. For example, a threshold for image brightness may be determined based on the signal to noise ratio (SNR) value of the image sensor 200, and the image brightness may be determined as a value within the threshold. Based thereon, the ISP 220 may calculate the distortion weight val for each pixel of the RGB image data according to Equation 2 based on edge connectivity Iₘᵢₙ for each pixel in the RGB image data, edge connectivity I_{min,corrected} for each pixel of corrected RGB image data and image brightness I_{SNR} for which the noise level of the image sensor 200 is considered.

$$v a l = \frac{diff ( {I}_{min} , {I}_{min , corrected} )}{{I}_{S N R}} \qquad [ Equation 2 ]$$

According to some example embodiments, the distortion weight for each pixel of the RGB image data may be calculated based on edge connectivity calculated based on Equation 1 for each of the R, G and B values of the RGB image data and the corrected RGB image data, and the maximum value among the distortion weights determined based on the edge connectivity calculated for each of a R value, a G value and a B value may be determined as the distortion weight for each pixel of the RGB image data. According to Equation 2, the larger the difference in edge connectivity between the RGB image data and the corrected RGB image data, the larger the distortion weight is, and the larger the distortion weight, the higher the image distortion level calculated according to the method described below. Therefore, by determining the maximum value among the distortion weights determined based on the edge connectivity calculated for each of the R value, the G value, and the B value as the distortion weight for each pixel of the RGB image data, the color correction may be performed based on the color value where color distortion is expected to be most severe.

According to some example embodiments, the distortion weight calculation module 224c may determine the image distortion level corresponding to each pixel based on the distortion weight corresponding to each pixel of the RGB image data. More specifically, a lower threshold value and an upper threshold value for the distortion weight may be set, and the image distortion level may be determined based on the lower threshold value, the upper threshold value, and the distortion weight corresponding to each pixel of the RGB image data. In some example embodiments, when the distortion weight corresponding to a specific pixel is smaller than the lower threshold value, it may be determined that there is no color distortion during the image data correction process, and the correction to alleviate color distortion may not be performed for the corresponding pixel. Further, when the distortion weight corresponding to a specific pixel is greater than the upper threshold value, it may be determined that the degree of color distortion is high during the image data correction process, and the maximum correction may be performed on the corresponding pixel to alleviate color distortion. Further, when the distortion weight corresponding to a specific pixel is between the lower threshold value and the upper threshold value, it may be determined that some degree of color distortion may occur during the image data correction process, and the degree of correction to alleviate color distortion may be determined depending on the expected degree of color distortion.

According to some example embodiments, the distortion weight calculation module 224c may determine the image distortion level corresponding to each pixel of the RGB image data as a distortion probability with a value between 0 and 1. More specifically, when the distortion weight corresponding to a specific pixel of the RGB image data is less than the lower threshold value, the image distortion level corresponding to the pixel may be determined to be 0. When the distortion weight corresponding to a specific pixel of the RGB image data is greater than the upper threshold value, the image distortion level corresponding to the pixel may be determined to be 1. Further, when the distortion weight corresponding to a specific pixel of the RGB image data has a value between the lower threshold value and the upper threshold value, as shown in Equation 3, an image distortion level P may be determined according to a linear function between a lower threshold value th_{L} and an upper threshold value th_{H}.

$$P = \frac{val - {th}_{L}}{{th}_{H} - {th}_{L}} \qquad [ Equation 3 ]$$

According to the above-described process, information about the image distortion level P that is output from the distortion weight calculation module 224c may be input to the color correction module 225, and the color correction module 225 may alleviate color distortion in the image data processing process by correcting the color of the image data based on information about the image distortion level P for each pixel of the RGB image data.

Referring to FIG. 4B, the color correction module 225 may include a chrominance representative value determination module 225a and a chrominance value correction module 225b.

According to some example embodiments, the chrominance representative value determination module 225a may determine a representative value of chrominance of the RGB image data based on the pixel value of the RGB image data that is input to the color correction module 225. More specifically, the RGB image data may be converted to YUV image data, the absolute value of chrominance may be calculated for each pixel of converted YUV image data, and the minimum value or the median value of the absolute value of the calculated chrominance may be determined as the representative value of the chrominance of the RGB image data input to the color correction module 225.

According to some example embodiments, the process of converting the RGB image data to YUV image data may be performed in the chrominance representative value determination module 225a, and the YUV image data converted by performing the color correction module 225 may be input to the chrominance representative value determination module 225a. Alternatively, the ISP 220 may include a module that converts the RGB image data into YUV image data, and the converted YUV image data may be input to the color correction module 225.

According to some example embodiments, in the process of converting the RGB image data to YUV image data, for each pixel of the RGB image data, a U value may be determined as the difference between the blue pixel value B and the green pixel value G, and a V value may be determined as the difference between the red pixel value R and the green pixel value G. A commonly used matrix to convert the RGB image data to YUV image data may be used, but by simplifying the operation for conversion to YUV image data, the data processing efficiency of the ISP 220 may be increased. For example, according to some example embodiments, there may be an increase in speed, accuracy, and/or power efficiency of the image processing device based on the above methods. Therefore, the improved devices and methods overcome the deficiencies of the conventional devices and methods while reducing resource consumption, and improving data accuracy, and resource allocation (e.g., latency). Further, there is an improvement in user experience and image capture in the device by providing the improved process.

According to some example embodiments, a representative value of the chrominance of the RGB image data determined through the chrominance representative value determination module 225a may be a standard for color correction. As described above, the chrominance of image data is the part that represents the color information of the image, and when the chrominance value is reduced for pixels where color distortion is expected to be boosted, the intensity of the color of the corresponding pixel is weakened, which may alleviate color distortion in the output image. Based thereon, for pixels where color distortion is expected to be boosted, the color intensity in the output image may be set to the minimum by minimizing the chrominance value. However, in some example embodiments, the color intensity of the entire output image may become inconsistent, which may boost color distortion, and thus the representative value of the chrominance must be determined based on the characteristics of the entire image.

In some example embodiments, the minimum value of the absolute value of the chrominance may be determined by the representative value of the chrominance. Alternatively, a pixel with the minimum value of the absolute value of the chrominance may have a value that is far from the absolute value of the chrominance of the entire image, and thus by determining the median value of the absolute value of the chrominance as the representative value of the chrominance, color distortion may be prevented from being boosted in the entire output image. Meanwhile, the present disclosure is not limited thereto, and a value determined to be appropriate as a reference for color correction such as a second smallest value, an average value and so on among absolute values of the chrominance of the RGB image data may be determined as the representative value of the chrominance.

In some example embodiments, the representative value of the chrominance may be determined based on the entire input image data. Alternatively, when the image data has large differences in brightness or color depending on the area, the image data may be divided into a plurality of areas, and a representative value of the chrominance may be determined for each of the plurality of areas. Here, the size of the divided areas may be determined based on the characteristics of the image data.

According to some example embodiments, when the chrominance representative value, which is the standard for color correction, is determined in the chrominance representative value determination module 225a, the chrominance value correction module 225b may correct the chrominance value for each pixel of the RGB image data based on the RGB image data, information on the image distortion level P, and the chrominance representative value. More specifically, for pixels with high image distortion level P, by correcting the chrominance value to be close to a representative value UVᵣₑₚᵣₑₛₑₙₜ of chrominance, correction may be made in a direction that may alleviate color distortion in the output image, and for pixels with low image distortion level P, correction may be made in the direction of preserving the original chrominance value UV_{original}. For example, the chrominance value correction module 225b may determine the corrected chrominance value UVcorrected of the image data based on Equation 4.

$$U {V}_{corrected} = P * U {V}_{r e p resent} + ( 1 - P ) * U {V}_{o r i g i n a l} \qquad [ Equation 4 ]$$

According to Equation 4, for a pixel with an image distortion level P of 0 among the pixels of the RGB image data, the original chrominance value may be maintained without chrominance correction, and for a pixel with an image distortion level P of 1, the chrominance value is corrected with the representative value of chrominance. Further, for a pixel with image distortion level P between 0 and 1, depending on the image distortion level P, the chrominance value is corrected to a value of the linear function between the representative value of chrominance and the original chrominance value.

According to some example embodiments, the color correction module 225 may generate RGB image data based on the corrected chrominance value of each pixel determined by the chrominance value correction module 225b. For example, the color correction module 225 may generate output YUV image data with corrected U and V values, and may convert output YUV image data into output RGB image data and transmit it to the Bayer transform module 226. In some example embodiments, the process of converting YUV image data to RGB image data may be performed in the chrominance value correction module 225b, and the RGB image data converted by performing the color correction module 225 may be input to the Bayer transform module 226. Further, the ISP 220 may include a module that converts YUV image data output from the color correction module 225 into RGB image data, and the converted RGB image data may be input to the Bayer transform module 226.

Further, in the Bayer transform module 226, the RGB image data may be converted into image data of Bayer pattern, and the image data of the converted Bayer pattern may be transmitted to the AP 300 as an output image of the image sensor 200, and subsequent image data processing may be performed in the AP 300 to reduce noise or improve image quality. In the present disclosure, example embodiments where the AP 300 processes Bayer pattern image data are described, but the form of the output image of the image sensor 200 may vary depending on the type of image data that the AP 300 may process.

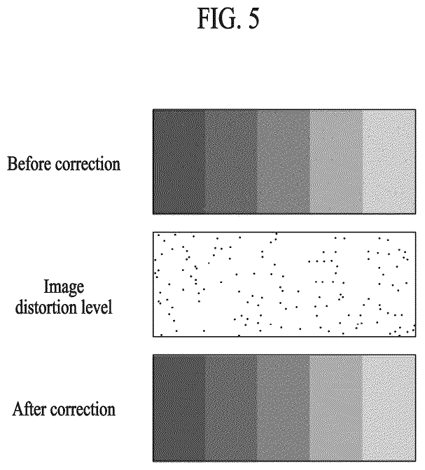

FIG. 5 is a diagram illustrating an output image to which an image processing method is applied according to some example embodiments.

FIG. 5 illustrates an output image after an image processing method including color correction to alleviate color distortion according to some example embodiments of the present disclosure is applied to image data with various contrast along with information about the color distortion level of the image data, and an output image where the image processing method is not applied.

As illustrated in FIG. 5, information about the color distortion level of the image data may include information about the positions of pixels whose color distortion level of the image data has a value other than 0. Pixels whose color distortion level in the image data has a non-zero value may be pixels that are expected to cause color distortion after processing image data in an AP, and to which color correction is applied according to the image processing method according to some example embodiments. In some example embodiments, only location information of pixels with a color distortion level other than 0 may be displayed, but by dividing the color distortion level into multiple sections and displaying them differently for each section, pixels with high and low color distortion levels may be displayed separately.

Referring to the output images illustrated in FIG. 5, in an output image where an image processing method according to some example embodiments is not applied, color distortion may occur where there are difference in color values between pixels with non-zero color distortion level and their surrounding pixels. Meanwhile, with respect to the output image to which the image processing method according to some example embodiments is applied, it may be identified that the color distortion is also alleviated for pixels with a color distortion level other than 0 and thus differences between surrounding pixels and color values are reduced.

In some example embodiments as illustrated in FIG. 5, only results for grayscale images are illustrated, but the image processing method according to the example embodiments of the present disclosure may equally be applied to various colors consisting of red, green, blue, and any combination of these colors. While the instant specification discusses red, green, and blue colors, the inventive concepts are not limited thereto, and may be related to additional color combinations, for example, CMY (cyan, magenta, and yellow) or inclusive of a white color, etc.

The electronic device according to the above-described example embodiments may include a processor, a memory for storing and executing program data, a permanent storage such as a disk drive, and/or a user interface device such as a communication port, a touch panel, a key and/or a button that communicates with an external device. Methods implemented as software modules or algorithms may be stored in a computer-readable recording medium as computer-readable codes or program instructions executable on the processor. Here, the computer-readable recording medium includes a magnetic storage medium (for example, ROMs, RAMs, floppy disks, and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

The example embodiments may be represented by functional block elements and various processing steps. The functional blocks may be implemented in any number of hardware and/or software configurations that perform specific functions. For example, some example embodiments may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

The above-described example embodiments are merely examples, and other embodiments may be implemented within the scope of the claims to be described later.

What is claimed is:

1. An image sensor comprising:
a pixel array including a plurality of pixels in a plurality of rows and a plurality of columns, the pixel array configured to generate a raw image; and
an image signal processor (ISP) configured to process the raw image and generate an output image,
wherein the ISP is configured to:
obtain the raw image;
generate RGB image data based on the raw image;
generate corrected RGB image data by applying a selected image data processing method to the RGB image data;
identify an image distortion level corresponding to each pixel of the RGB image data by comparing the RGB image data with the corrected RGB image data;
correct each chrominance value corresponding to each pixel of the RGB image data based on the image distortion level corresponding to each pixel of the RGB image data; and
generate the output image based on each corrected chrominance value.

2. The image sensor of claim 1, wherein the ISP is configured to determine a pixel value of each pixel of the RGB image data by interpolation of pixel values of each pixel of the raw image.

3. The image sensor of claim 1, wherein
the selected image data processing method comprises at least one image data processing method that causes the corrected RGB image data to have non-linearity, and
the ISP is configured to generate the corrected RGB image data by applying at least one of gamma correction, color correction, or shading correction to the RGB image data.

4. The image sensor of claim 3, wherein each parameter related to the gamma correction, the color correction, and the shading correction is determined based on parameters related to the gamma correction, the color correction, and the shading correction of an application processor.

5. The image sensor of claim 1, wherein the ISP is configured to:
calculate edge connectivity of each pixel of the RGB image data;
calculate edge connectivity of each pixel of the corrected RGB image data;
calculate distortion weight corresponding to each pixel of the RGB image data based on the edge connectivity of each pixel of the RGB image data, the edge connectivity of each pixel of the corrected RGB image data and a noise level of the image sensor; and
calculate an image distortion level corresponding to each pixel of the RGB image data based on the distortion weight.

6. The image sensor of claim 5, wherein, with respect to each pixel of image data, the ISP is configured to calculate the edge connectivity based on a pixel value of a pixel and a pixel value of each neighboring pixel.

7. The image sensor of claim 5, wherein the ISP is configured to determine the image distortion level corresponding to each pixel of the RGB image data based on a lower threshold value, an upper threshold value, and the distortion weight corresponding to each pixel of the RGB image data.

8. The image sensor of claim 7, wherein the lower threshold value and the upper threshold value are determined based on the noise level of the image sensor.

9. The image sensor of claim 1, wherein the ISP is configured to:
determine a representative value of each chrominance value of the RGB image data; and
correct each chrominance value of the each pixel based on the image distortion level of each pixel of the RGB image data, each chrominance value of each pixel of the RGB image data, and the representative value.

10. The image sensor of claim 9, wherein the ISP is configured to:
convert the RGB image data into YUV image data;
calculate an absolute value of each chrominance value for each pixel of the YUV image data; and
determine a minimum value or a median value of the absolute value of each chrominance value for each pixel of the YUV image data as the representative value.

11. The image sensor of claim 10, wherein with respect to each pixel of the RGB image data, the ISP is configured to determine a value of U based on a difference between a blue pixel value and a green pixel value, and a value of V based on a difference between a red pixel value and the green pixel value.

12. The image sensor of claim 1, wherein the ISP is configured to:
generate output RGB image data of which each chrominance of each pixel has each corrected chrominance value; and
generate the output image by converting the output RGB image data into a Bayer pattern.

13. The image sensor of claim 1, wherein the raw image is an image of a tetra pattern or an image of a nona pattern.

14. An image processing system comprising:
an image sensor comprising
a pixel array including a plurality of pixels in a plurality of rows and a plurality of columns, the pixel array configured to generate a raw image, and
an image signal processor (ISP) configured to process the raw image and generate an output image; and
an application processor configured to process the output image to generate a final output image,
wherein the ISP is configured to:
obtain the raw image;
generate RGB image data based on the raw image;
generate corrected RGB image data by applying a selected image data processing method to the RGB image data;
identify an image distortion level corresponding to each pixel of the RGB image data by comparing the RGB image data and the corrected RGB image data;
correct a chrominance value corresponding to each pixel of the RGB image data based on the image distortion level corresponding to each pixel of the RGB image data; and
generate the output image based on a corrected chrominance value.

15. The image processing system of claim 14, wherein the ISP is configured to:
calculate edge connectivity of each pixel of the RGB image data;
calculate edge connectivity of each pixel of the corrected RGB image data;
calculate distortion weight corresponding to each pixel of the RGB image data based on the edge connectivity of each pixel of the RGB image data, the edge connectivity of each pixel of the corrected RGB image data and a noise level of the image sensor; and
calculate an image distortion level corresponding to each pixel of the RGB image data based on the distortion weight.

16. The image processing system of claim 15, wherein, with respect to each pixel of image data, the ISP is configured to calculate the edge connectivity based on a pixel value of a pixel and a pixel value of each neighboring pixel.

17. The image processing system of claim 15, wherein the ISP is configured to determine the image distortion level corresponding to each pixel of the RGB image data based on a lower threshold value, an upper threshold value and the distortion weight corresponding to each pixel of the RGB image data.

18. An image processing method comprising:
obtaining a raw image generated by a pixel array;
generating RGB image data based on the raw image;
generating corrected RGB image data by applying a selected image data processing method to the RGB image data;
identifying an image distortion level corresponding to each pixel of the RGB image data by comparing the RGB image data and the corrected RGB image data;
correcting a chrominance value corresponding to each pixel of the RGB image data based on the image distortion level corresponding to each pixel of the RGB image data; and
generating an output image based on a corrected chrominance value.

19. The image processing method of claim 18, wherein identifying the image distortion level corresponding to each pixel of the RGB image data comprises:
calculating edge connectivity of each pixel of the RGB image data;
calculating edge connectivity of each pixel of the corrected RGB image data;
calculating distortion weight corresponding to each pixel of the RGB image data based on the edge connectivity of each pixel of the RGB image data, the edge connectivity of each pixel of the corrected RGB image data and a noise level of an image sensor; and
calculating an image distortion level corresponding to each pixel of the RGB image data based on the distortion weight.

20. The image processing method of claim 18, wherein the correcting the chrominance value comprises:
determining a representative chrominance value of the RGB image data; and
correcting each chrominance value of each pixel based on the image distortion level of each pixel, each chrominance value of each pixel, and the representative chrominance value.
